(19) United States
(12) Patent Application Publication
(10) Pub. No.: US 2008/0178820 A1
(43) Pub. Date: Jul. 31, 2008

(54) Habitat Extender

(76) Inventor: Karen Young, Elma, WA (US)

Correspondence Address: PATWRITE LLC, 408 W. MAIN ST., MARSHALLTOWN, IA, 50158-5759, US

(21) Appl. No.: 12/021,954

(22) Filed: Jan. 29, 2008

Related U.S. Application Data
(60) Provisional application No. 60/887,034, filed on Jan. 29, 2007.

(51) Int. Cl. A01K 1/03

(52) U.S. Cl. 119/480

(57) ABSTRACT

A habitat extender comprises a floor panel which has a plurality of tabs along at least a portion of the perimeter the floor panel dimensioned to fit within the bars of a cage. A rod is inserted through the tabs to secure the floor panel to the cage. In one embodiment, the habitat extender comprises the bottom floor panel and a top floor panel are joined to define a pocket like living space with opposing non-concentric openings providing access to the pocket and to other parts of the habitat. The openings are non-concentrically disposed to prevent an animal from falling straight through. The habitat extender is removable for easy cleanup.

### RELATED APPLICATIONS

This application claims priority and herein incorporates by reference U.S. provisional patent application 60/887,034 filed Jan. 29, 2007.

### BACKGROUND OF THE INVENTION

Humans have been using cages for a very long time. According to the American Pet Products Manufacturers Association, about 5% to total US households owned a small animal in 2004. Further according to the survey, the total number of small animal pets in 2004 was 18.2 million. Most of these pets will spend their lives in cages. Most pet owners want their animals to enjoy their space and consider the living space to be a habitat rather than merely a cage. Cages range from inexpensive boxlike containers to high quality multilevel expensive habitats.

There is a need for a habitat extender that is added to a cage to create additional living space for small animals that is easily removable for cleaning.

A habitat extender comprises a floor panel which has a plurality of tabs along at least a portion of the perimeter the floor panel dimensioned to fit within the bars of a cage. A rod is inserted through the tabs to secure the floor panel to the cage. In one embodiment, the habitat extender comprises the bottom floor panel and a top floor panel are joined to define a pocket like living space with opposing non-concentric openings providing access to the pocket and to other parts of the habitat. The openings are non-concentrically disposed to prevent an animal from falling straight through. The habitat extender is removable for easy cleanup.

Other features and advantages of the instant invention will become apparent from the following description of the invention which refers to the accompanying drawings.

### BRIEF DESCRIPTION OF THE DRAWINGS

FIG. 1 is a top view of a habitat extender floor panel according to an embodiment of the present invention.

FIG. 2 is a top view of a habitat extender floor panel with a cutout according to an embodiment of the present invention.

FIG. 3 is a top view of a habitat extender partial floor panel according to an embodiment of the present invention.

FIG. 4 is a top view of a habitat extender floor panel with a cutout according to an embodiment of the present invention.

FIG. 5 is a top view of a habitat extender floor panel having an opening according to an embodiment of the present invention.

FIG. 6 is a top view of a habitat extender partial floor panel according to an embodiment of the present invention.

FIG. 7 is a perspective view of a habitat extender mounted in a cage according to an embodiment of the present invention.

FIG. 8 is a perspective view of multiple habitat extenders mounted in a cage according to an embodiment of the present invention.

FIG. 9 is a perspective view of a habitat extender pocket mounted in a cage according to an embodiment of the present invention.

FIG. 10 is a side cutaway view of a habitat extender pocket according to an embodiment of the present invention.

FIG. 11 is a perspective view of a habitat extender mounted in a cage according to an embodiment of the present invention.

FIG. 12 is a detail view of the portion shown in FIG. 11 according to an embodiment of the present invention.

### DETAILED DESCRIPTION OF THE INVENTION

Reference is now made to the drawings in which reference numerals refer to like elements.

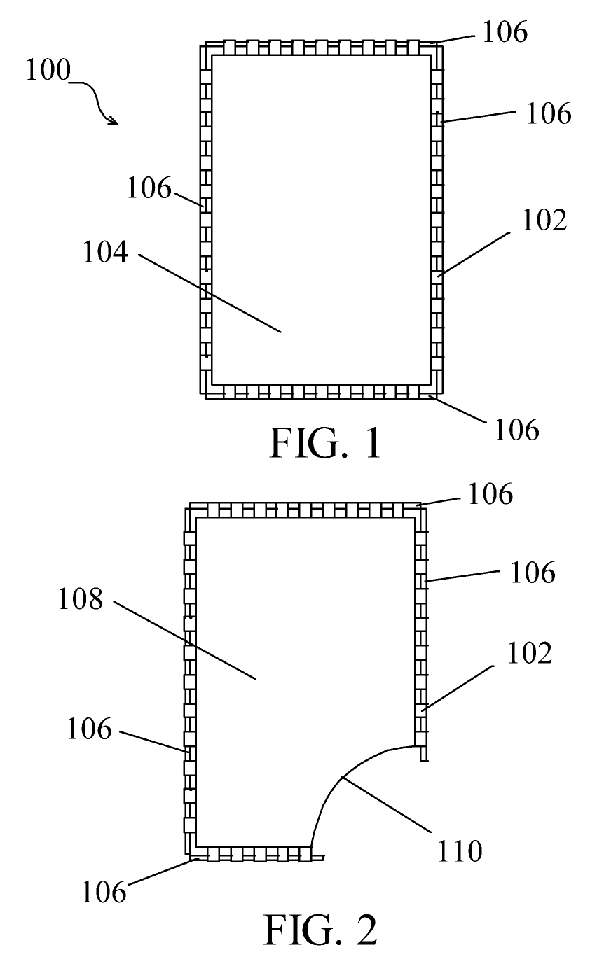

Referring now to FIG. 1, a habitat extender 100 is shown having a main floor panel 104 with a plurality of tabs 102 along the perimeter. Rods 106 are inserted through tabs 102 to secure habitat extender 100 to a cage.

Now referring to FIG. 2, a habitat extender has a main floor panel 108 with a cutaway section 110 to allow an animal (not shown) to pass through a habitat extender.

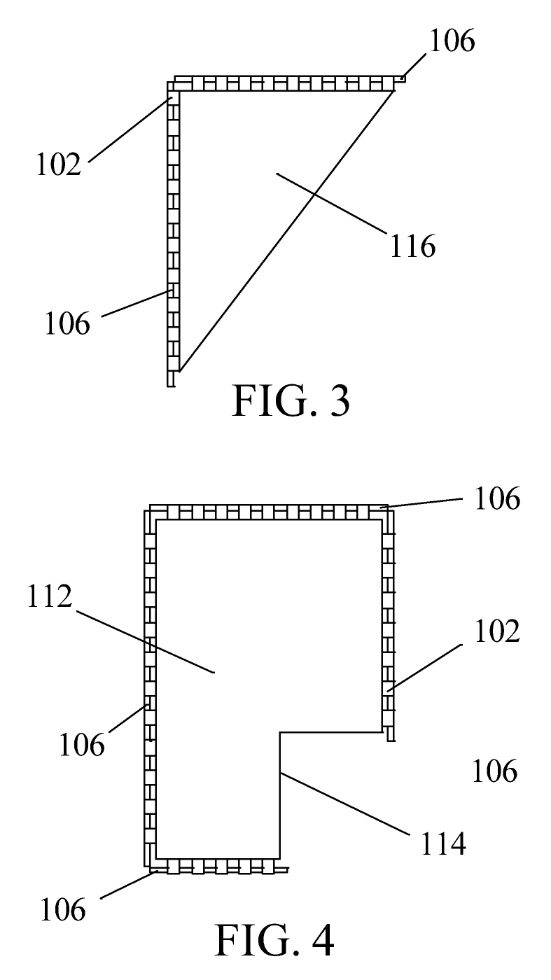

FIG. 3 illustrates a habitat extender that fits within a corner of the cage (not shown) and has a main floor panel 116 that sections off less than an entire level of the cage.

With reference to FIG. 4, a habitat extender is shown having a main floor panel 112 with a cutout 114 again providing access through the habitat extender to other portions of the cage.

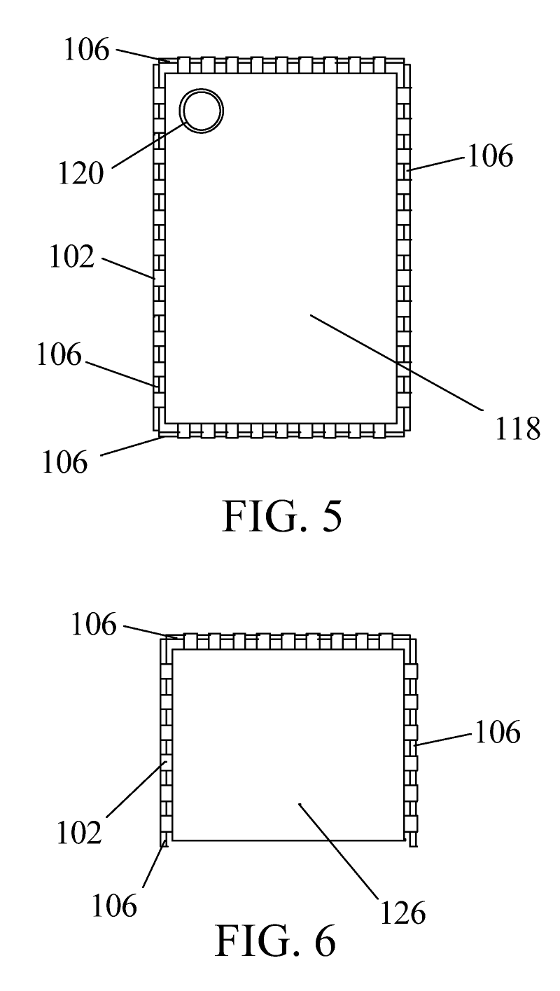

FIG. 5 shows a habitat extender having a main floor panel 118 with an access hole 120 to allow an animal to climb through the habitat extender.

FIG. 6 illustrates a habitat extender meant to enclose less than an entire level of the cage. It includes a main floor panel 126 that is bounded on three sides by tabs 102 leaving a free edge. Rods 106 again are inserted through tabs 102 but only on three sides.

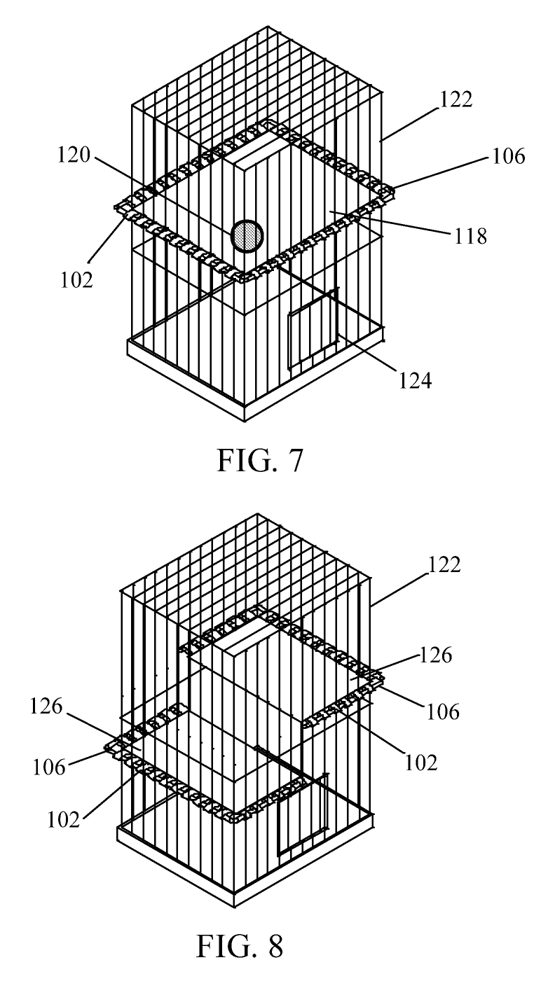

Now referring to FIG. 7, a cage 122 is shown having a habitat extender having a main floor panel 118 with access hole 120 and tabs 102 inserted through the bars of cage 122. Rods 106 are inserted through tabs 102 to secure the habitat extender to cage 122. A typical cage door 124 is shown providing access to an interior portion of cage 122.

Referring now to FIG. 8, a plurality of habitat extenders are shown secured to cage 122. The habitat extenders each have partial floor panels 126 secured on three sides by inserting tabs 102 through bars in cage 122 and then inserting rods 106 through tabs 102 to secure the habitat extenders.

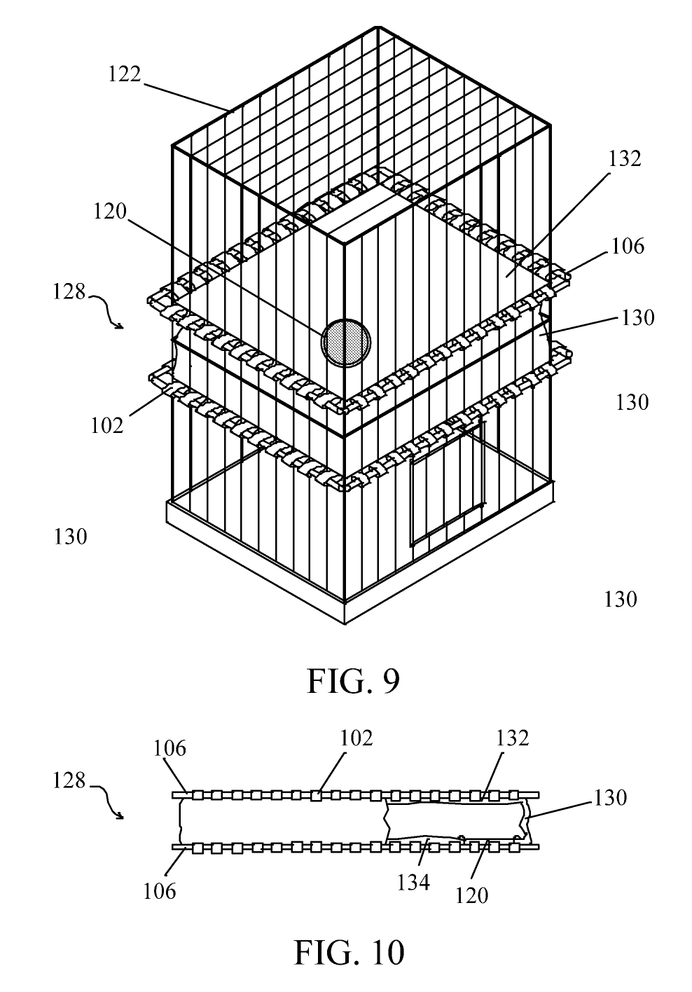

A pocket habitat extender is shown in FIGS. 9 and 10 having a top pocket portion 132 and a bottom pocket portion 134 connected by at least one side wall portion 130. Both the top pocket portion 132 and the bottom pocket portion 134 have a plurality of tabs 102 which are inserted between the bars of cage 122 and secured with rods 106 as discussed above. A pocket space is defined within top pocket portion 132 and bottom pocket portion 134 and may be lined with fir or other soft material to provide a snug living compartment for an animal. Access opening 120 is provided in top pocket panel 132 and a similar opening 120 is provided in bottom pocket panel 134 at an opposite end to prevent an animal from falling straight through pocket habitat extender.

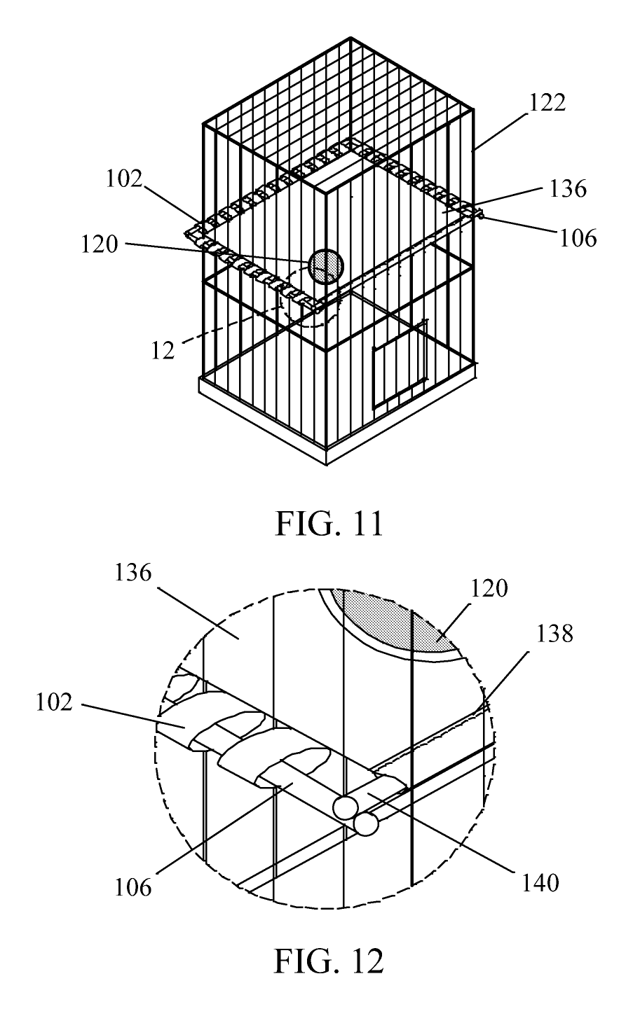

Referring now to FIGS. 11 and 12, an embodiment of a habitat extender having a plurality of tabs 102 on three sides and a seam 138 along the fourth side is shown inserted in cage 122. This embodiment provides support on all edges of a floor panel 136 but does not require tabs 102 on one side. This embodiment may be used when tabs 102 would interfere with the operation of cage 122 such as when a cage has oversized doors (not shown). A special rod 140 is used by sliding it through an opening created by looping the edge of floor panel 136 over and sewing seam 138 along its length. Rod 140 may be supported by resting on top of rods 106 as shown or rod 140 may rest on a longitudinal cage support (not shown). Rod 140 may be the same as rods 106.

Although the instant invention has been described in relation to particular embodiments thereof, many other variations and modifications and other uses will become apparent to those skilled in the art.

What is claimed is:

1. A habitat extender for use in a wire cage comprises:
at least two support rods;
a floor panel; and
a plurality of tabs disposed around a substantial portion of the perimeter of said floor panel wherein said plurality of tabs fit within spaces disposed in said wire cage and said at least two support rods engage with said plurality of tabs to securely hold said floor panel to said wire cage.

2. A habitat extender for use in a wire cage according to claim 1 wherein said floor panel is fur lined.

3. A habitat extender for use in a wire cage according to claim 1 further comprising:
a second floor panel disposed below said first floor panel;
a wall portion disposed around the perimeter of said first and second floor panels wherein a living space is enclosed therein;
at least one opening in said floor panel; and
at least one opening in said second floor panel.

4. A habitat extender for use in a wire cage according to claim 3 wherein said at least one opening in said floor panel and said at least one opening in said second floor panel are disposed along separate axis wherein said openings are non-concentric.

5. A habitat extender for use in a wire cage according to claim 3 wherein at least one of said floor panels is fur lined.

6. A habitat extender for use in a wire cage according to claim 1 wherein said floor panel has at least one opening disposed therein.

7. A method of extending a habitat in a wire cage comprising the steps of:
obtaining a habitat extender;
fitting said habitat extender within wires of said wire cage;
slipping a first support rod through a plurality of tabs disposed around the perimeter of said habitat extender; and
slipping at least one other support rod through a plurality of tabs disposed around the perimeter of said habitat extender.
